(19) United States
(12) Patent Application Publication
(10) Pub. No.: US 2006/0118546 A1
(43) Pub. Date: Jun. 8, 2006

(54) Firing furnace and method for manufacturing porous ceramic fired object with firing furnace

(75) Inventor: Takamitsu Saijo, Gifu (JP)

Correspondence Address: NIXON & VANDERHYE, PC, 901 NORTH GLEBE ROAD, 11TH FLOOR, ARLINGTON, VA, 22203, US

(73) Assignee: IBIDEN CO., LTD., Ogaki-shi (JP)

(21) Appl. No.: 11/312,488

(22) Filed: Dec. 21, 2005

Related U.S. Application Data
(63) Continuation of application No. PCT/JP05/14315, filed on Aug. 4, 2005.

(30) Foreign Application Priority Data
Aug. 4, 2004 (JP) 2004-228571

(51) Int. Cl. H05B 3/06

(52) U.S. Cl. 219/542

(57) ABSTRACT

A firing furnace includes a housing, having a firing chamber for receiving a firing subject, and a plurality of heating elements for generating heat when supplied with current to heat the firing subject in the firing chamber. Each heating element is formed of a material containing irregularly oriented crystal grains. Each heating element is manufactured by applying pressure entirely to a flexible mold, containing a powder composition, with a pressurizing medium to form a molded product (firing subject) of the powder composition, firing the molded product at a first temperature, and then firing the molded product again at a second temperature that is higher than the first temperature.

### CROSS-REFERENCE TO RELATED APPLICATIONS

This application is a continuation of, and claims the benefit of priority from International PCT Application PCT/JP2005/014315, filed on Aug. 4, 2005, the entire contents of which are incorporated herein by reference.

### BACKGROUND OF THE INVENTION

The present invention relates to a firing furnace, and more particularly, to a resistance-heating firing furnace for firing a molded product of a ceramic material and a method for manufacturing a porous ceramic fired object with the firing furnace.

A molded product of a ceramic material is typically fired in a resistance-heating firing furnace at a relatively high temperature. An example of a resistance-heating firing furnace is disclosed in JP-A 2002-193670. This firing furnace includes a plurality of rod heaters arranged in a firing chamber for firing a molded product. A material having superior heat-resistance is used for the resistance-heating firing furnace to enable firing at high temperatures. In the conventional firing furnace, electric current is supplied to the rod heaters to generate heat. The radiation heat from the rod heaters heats and sinters the molded product in the firing chamber to manufacture a ceramic sinter.

The contents of JP-A 2002-193670 are incorporated herein by reference in their entirety.

### SUMMARY OF THE INVENTION

One aspect of the present invention is a firing furnace for firing a firing subject, the furnace including a housing including a firing chamber for receiving the firing subject, and a plurality of heating elements for generating heat when supplied with current to heat the firing subject in the firing chamber. Each of the heating elements is formed of a material containing irregularly oriented crystal grains.

The present invention further provides a method for manufacturing a porous ceramic fired object, the method including the steps of forming a firing subject from a composition containing ceramic powder, and firing the firing subject. The step of firing includes is performed with a firing furnace including a housing having a firing chamber and a plurality of heating elements formed of a material containing irregularly oriented crystal grains and generating heat when supplied with current to heat the firing subject in the firing chamber.

In one aspect of the present invention, the material is a ceramic material formed by a cold isotropic pressing method. It is preferred that the ceramic material has a porosity of about 5% to about 20% in terms of a value measured by performing mercury intrusion porosimetry. In one aspect, the ceramic material is carbon. In one aspect, the firing furnace further includes a support member for supporting the plurality of heating elements. The heating elements are each indirectly supported by the housing in a state connected to the support member. It is preferred that the support member is formed of a material having a porosity adjusted within a range of about 5% to about 20% in terms of a value measured by performing mercury intrusion porosimetry. The firing furnace may perform firing at a first temperature and a second temperature, which is higher than the first temperature. In one aspect, the firing furnace is a continuous firing furnace for continuously firing a plurality of the firing subjects.

The present invention further provides a furnace for performing firing upon subjects, the furnace including a housing including a chamber for receiving and firing the subjects. A plurality of resistance heating elements are disposed for generating heat in the chamber when the resistance heating elements are supplied with electric current for heating and firing the subjects in the chamber, with each resistance heating element being comprised of a ceramic material having isotropic characteristics.

Other aspects and advantages of the present invention will become apparent from the following description, taken in conjunction with the accompanying drawings, illustrating by way of example the principles of the invention.

### BRIEF DESCRIPTION OF THE DRAWINGS

FIG. 1 is a schematic cross-sectional view of a firing furnace according to preferred embodiment of the present invention;

FIG. 2 is a cross-sectional view taken along line 2-2 on the firing furnace of FIG. 1;

FIG. 3 is an enlarged view showing an electrode member of the firing furnace of FIG. 1;

FIG. 4 is a cross-sectional view of a cold isotropic pressing device used in the formation of a firing subject;

FIG. 5 is a perspective view showing a particulate filter for purifying exhaust gas; and

FIGS. 6A and 6B are respectively a perspective view and a cross-sectional view showing a ceramic member used for manufacturing the particulate filter of FIG. 5.

### DETAILED DESCRIPTION OF THE PREFERRED EMBODIMENTS

A firing furnace according to a preferred embodiment of the present invention will now be described.

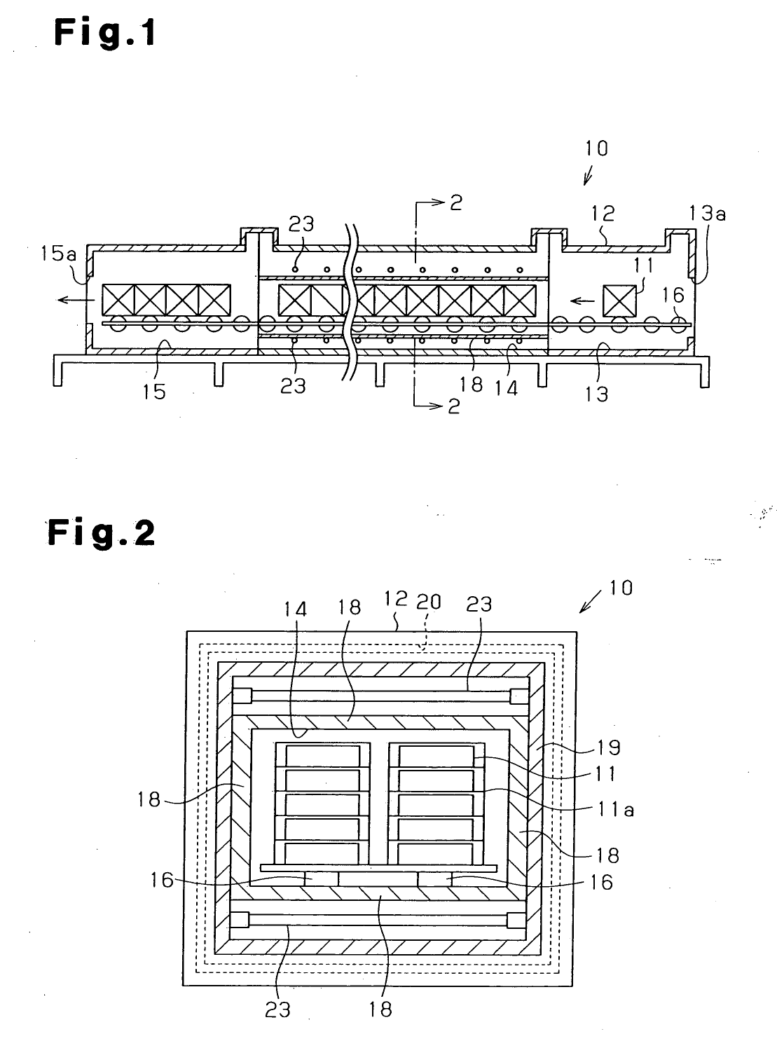

FIG. 1 shows a firing furnace 10 used in a manufacturing process of a ceramic product. The firing furnace 10 includes a housing 12 having a loading port 13a and an unloading port 15a. Firing subjects 11 are loaded into the housing 12 through the loading port 13a, and conveyed from the loading port 13a towards the unloading port 15a. The firing furnace 10 is a continuous firing furnace for continuously firing the firing subjects 11 in the housing 12. An example of a raw material for the firing subjects is ceramics such as porous silicon carbide (SiC), silicon nitride (SiN), sialon, cordierite, and carbon.

A pretreatment chamber 13, a firing chamber 14, and a cooling chamber 15 are defined in the housing 12. A plurality of conveying rollers 16 for conveying the firing subjects 11 are arranged along the bottom surfaces of the chambers 13 to 15. As shown in FIG. 2, a support base 11b is mounted on the conveying rollers 16. The support base 11b supports a plurality of stacked firing jigs 11a. Firing subjects 11 are placed on each of the firing jigs 11a. The support base 11b is pushed from the loading port 13a towards the unloading port 15a. The firing subjects 11, the firing jigs 11a, and the support base 11b are conveyed, by the rolling of the conveying rollers 16, through the pretreatment chamber 13, the firing chamber 14, and the cooling chamber 15 sequentially in this order.

An example of a firing subject 11 is a molded product formed by compression molding a ceramic material. The firing subject 11 is treated in the housing 12 as it moves at a predetermined speed. The firing subject 11 is sintered when passing through the firing chamber 14. Ceramic powder, which forms each firing subject 11, is sintered during the conveying process to produce a sinter. The sinter is conveyed into the cooling chamber 15 and cooled down to a predetermined temperature. The cooled sinter is discharged from the unloading port 15a.

The structure of the firing furnace 10 will now be described.

FIG. 2 is a cross-sectional view taken along line 2-2 in FIG. 1. As shown in FIG. 2, furnace walls 18 define an upper surface, a lower surface face, and two side surfaces of the firing chamber 14. The furnace walls 18 and the firing jigs 11a are formed of a high heat resistant material such as carbon.

A heat-insulating layer 19 formed of carbon fibers or the like is arranged between the furnace walls 18 and the housing 12. A water-cooling jacket 20 is embedded in the housing 12 for circulating cooling water. The heat-insulating layer 19 and the water-cooling jacket 20 prevent metal components of the housing 12 from being deteriorated or damaged by the heat of the firing chamber 14.

A plurality of rod heaters (heating elements) 23 are arranged on the upper side and lower side of the firing chamber 14, or arranged so as to sandwich the firing subjects 11, in the firing chamber 14. In the embodiment, the rod heaters 23 are each cylindrical and has a longitudinal axis extending in the lateral direction of the housing 12 (in the direction orthogonal to the conveying direction of the firing subjects 11). The rod heaters 23 are held between opposite walls of the housing 12. The rod heaters 23 are arranged parallel to each other in predetermined intervals. The rod heaters 23 are arranged throughout the firing chamber 14 from the entering position to the exiting position of the firing subjects 11.

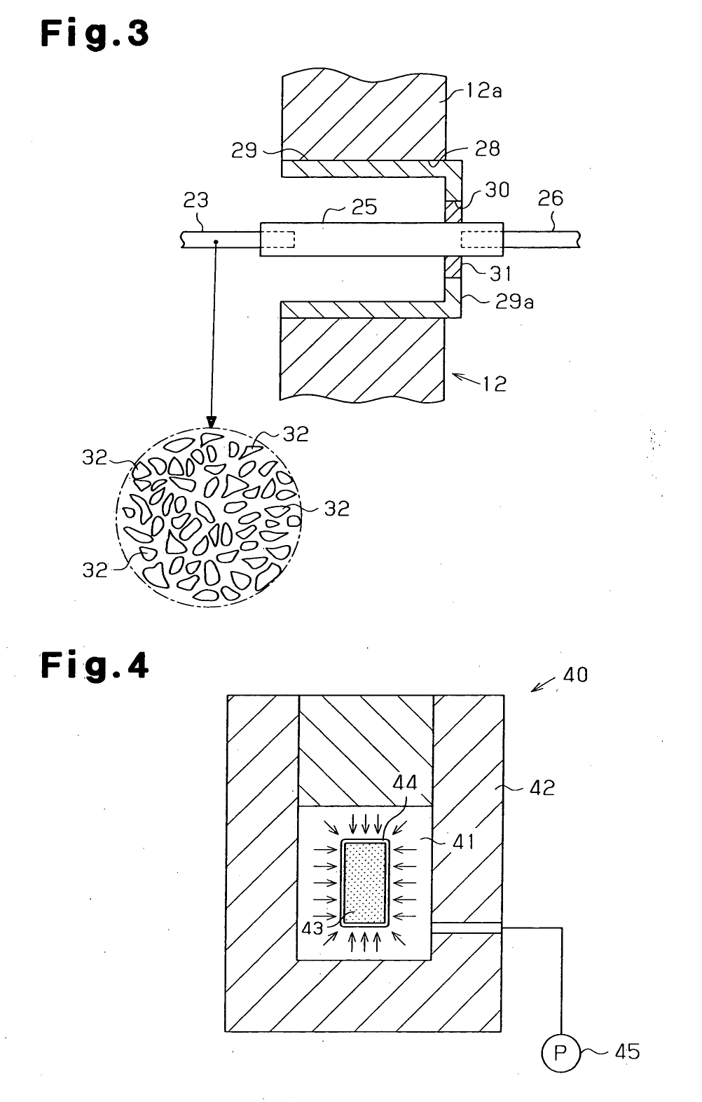

As shown in FIG. 3, each of the rod heaters 23 is electrically connected to a power supply (not shown), which forms part of the firing furnace 10, by a connector 25 and a metal electrode member 26. Each of the rod heaters 23 is supplied with current from the power supply located outside the housing 12 through the connector 25 and the electrode member 26. The rod heaters 23 generate heat when supplied with current to heat the interior of the firing chamber 14 to a predetermined temperature.

The connector 25 is formed into a tubular shape. The connector 25 has one end connected to the rod heater 23 and another end connected to the electrode member 26. A fixing hole 28 is formed in a side wall 12a of the housing 12 at a position corresponding to each of the rod heaters 23 in the firing chamber 14. A cup-shaped outer cover 29 having a bottom 29a is fitted to the fixing hole 28. The bottom 29a is exposed to the outer surface of the housing 12. The connector 25 is fixed in a fixing hole 30 formed in the center of the bottom 29a of the outer cover 29. This stably supports the rod heater 23 and the electrode member 26. The connector 25 functions as a support member for indirectly supporting the rod heater 23 relative to the housing 12. In the embodiment, a ring-shaped insulating member 31 is arranged between the fixing hole 30 of the outer cover 29 and the connector 25. The connector 25 and the outer cover 29 are formed, for example, of a high heat resistant material such as carbon.

The ceramic material forming the rod heater 23 and the connector 25 includes irregularly oriented crystal grains 32 (see FIG. 3). The ceramic material preferably has a porosity of about 5 to about 20% in terms of a value measured by performing mercury intrusion porosimetry. The mercury intrusion porosimetry refers to a method in which mercury is pressurized and charged into pores in the surface and interior of a specimen, and the specific surface area and pore distribution are calculated based on the pressure and quantity of the mercury charged into the specimen. If the porosity of the ceramic material is in the range of about 5% to about 20%, this prevents product yield from being decreased for reasons concerning its manufacturing process. This tends not to accelerate surface erosion caused by high temperature gas. This prevents meltdown in the rod heaters 23 and the connectors 25 and prolongs the durability of the rod heaters 23 and the connectors 25. Carbon is preferred as the ceramic material because of its high heat resistance. Graphite is also preferred as the ceramic material because of its high heat resistance, high electrical conductivity, and high machinability.

A method for manufacturing the ceramic components (rod heater 23 and connector 25) will now be described.

Coke, which serves as a raw material, is crushed to form coke powder having a grain size adjusted to a predetermined value. The maximum particle size for the coke powder is preferably about 0.02 to about 0.05 mm. Pitch, which serves as a binder, is added to and kneaded with the coke powder to prepare a powder composition. A molded product (firing subject) is produced from the powder composition. The molding is performed, for example, through pressurization, preferably by a cold isotropic pressing method (CIP method). The pressure used for the pressure forming is, for example, approximately 3000 kgf/cm². The shape of the molded product is, for example, a block. Alternatively, the molded product may have the same shape as the rod heater 23 or connector 25. The molded product is fired at a relatively high temperature (first temperature). This sinters the coke powder of the molded product and produces a sinter formed of a carbon material. The sinter is then fired at a temperature higher than the first temperature (second temperature). This graphitizes the carbon material of the sinter and produces a crude ceramic component formed of the graphite material (ceramic material). Then, a ceramic component is manufactured by shaping the crude ceramic component. In one example, the first and second temperatures are respectively approximately 1000° C. and approximately 3000° C.

The cold isotropic pressing method will be described with reference to FIG. 4. A cold isotropic pressing device (CIP device) 40 includes a rubber mold 44, with a powder composition 43 sealed therein, a pressure container 42 containing a pressurizing medium (fluid) 41 such as water and the rubber mold 44, and a pump 45 for applying pressure to the rubber mold 44 (and to the powder composition 43) by means of the pressurizing medium 41. The pressurizing medium 41 pressurized by the pump 45 applies uniform pressure to the entire surface of the rubber mold 44. This compresses the powder composition 43 in the rubber mold 44 with uniform pressure and molds a molded product into a shape defined by the rubber mold 44. The porosity of the molded product of the powder composition 43 is adjusted by adjusting the applied pressure. In the sinter (ceramic component) produced by firing the molded product, irregular orientation of the crystal grains of the ceramic material is facilitated. Further, the porosity of the ceramic material is easily adjusted to within the preferable range.

The preferred embodiment has the advantages described below.

(1) The ceramic material forming the rod heaters 23 and connectors 25 includes irregularly oriented crystal grains. Thus, the ceramic material has isotropic characteristics. The use of the resistance heating elements, or the rod heaters 23, formed of such isotropic material decreases differences in electrical characteristics between the rod heaters 23, such as electric resistance, and thus decreases the differences in the heating characteristics (quality). Accordingly, the firing furnace 10 performs heating at a uniform temperature and satisfies the desired firing performance. More specifically, electric conduction control of the rod heaters 23 is easily performed, and the temperature in the firing chamber 14 is easily stabilized. Further, the resistance difference between the rod heaters 23 is decreased. Accordingly, progress in deterioration or damage caused by heat generation becomes uniform among the rod heaters 23, and the rod heaters 23 have the same durability. As a result, in the firing furnace 10, each of the plurality of rod heaters 23 is efficiently used for a long period of time.

(2) The ceramic material forming the rod heaters 23 and the connectors 25 has a porosity of about 5 to about 20% in terms of a value measured by performing mercury intrusion porosimetry. By forming the rod heaters 23 and connectors 25 of the ceramic material with such a low porosity, the quantity of pores exposed to the surface is minimized. In the preferred embodiment, although the entire portion of each rod heater 23 and the portions of each connector 25 connected to the rod heater 23 are always exposed to a high temperature gas atmosphere in the firing chamber 14, the area that comes into contact with the gas generated in the firing chamber 14 is reduced since the number of pores exposed to the surface of the rod heaters 23 and connectors 25 is small. Accordingly, reaction of the rod heaters 23 and connectors 25 with the high temperature gas is suppressed to a low level, and meltdown or surface erosion caused by the high temperature gas is suppressed. As a result, the durability of the rod heaters 23 and the connectors 25 is prolonged.

(3) The ceramic material forming the rod heaters 23 and the connectors 25 is formed by the cold isotropic pressing method. Therefore, the ceramic material has isotropic characteristics. This reduces differences between the rod heaters 23 in quality related to electrical characteristics and makes it easy for the rod heaters 23 to have uniform heating characteristics. Further, the ceramic material has fewer pores exposed to the surface. Therefore, the meltdown or surface erosion caused by the high temperature gas is suppressed, and the durability of the rod heaters 23 and the connectors 25 is prolonged.

(4) Carbon is preferable and graphite is further preferable as the ceramic material for forming the rod heaters 23 and connectors 25 because of their superior heat resistance. This prolongs the durability of the rod heaters 23 and the connectors 25.

(5) The firing furnace 10 is a continuous firing furnace in which the firing subjects 11 that enter the housing 12 are continuously fired in the firing chamber 14. When mass producing ceramic products, the employment of the continuous firing furnace substantially drastically improves productivity in comparison with a conventional batch firing furnace.

(6) Differences in electrical characteristics between the rod heaters 23 can be decreased and differences between the rod heaters in and heating characteristics such as heating amount and temperature increase rate can be prevented. Accordingly the firing furnace 10 using the rod heaters 23 having uniform heating characteristics (qualities), the temperature in the furnace 10 can be stable and even. This ensures to obtain desired firing performance.

The method for manufacturing a porous ceramic fired object with a firing furnace according to a preferred embodiment of the present invention will now be described.

A porous ceramic fired object is manufactured by molding firing material to prepare a molded product and firing the molded product (firing subject). Examples of the firing material include: nitride ceramics such as aluminum nitride, silicon nitride, boron nitride and titanium nitride; carbide ceramics such as silicon carbide, zirconium carbide, titanium carbide, tantalum carbide and tungsten carbide; oxide ceramics such as alumina, zirconia, cordierite, mullite and silica; mixtures of several firing materials such as a composite of silicon and silicon carbide; and oxide and non-oxide ceramics containing plural types of metal elements such as aluminum titanate.

A preferable porous ceramic fired object is a porous non-oxide fired object having high heat resistance, superior mechanical characteristics, and high thermal conductivity. A particularly preferable porous ceramic fired object is a porous silicon carbide fired object. A porous silicon carbide fired object is used as a ceramic member, such as a particulate filter or a catalyst carrier, for purifying (converting) exhaust gas from an internal combustion engine such as a diesel engine.

A particulate filter will now be described.

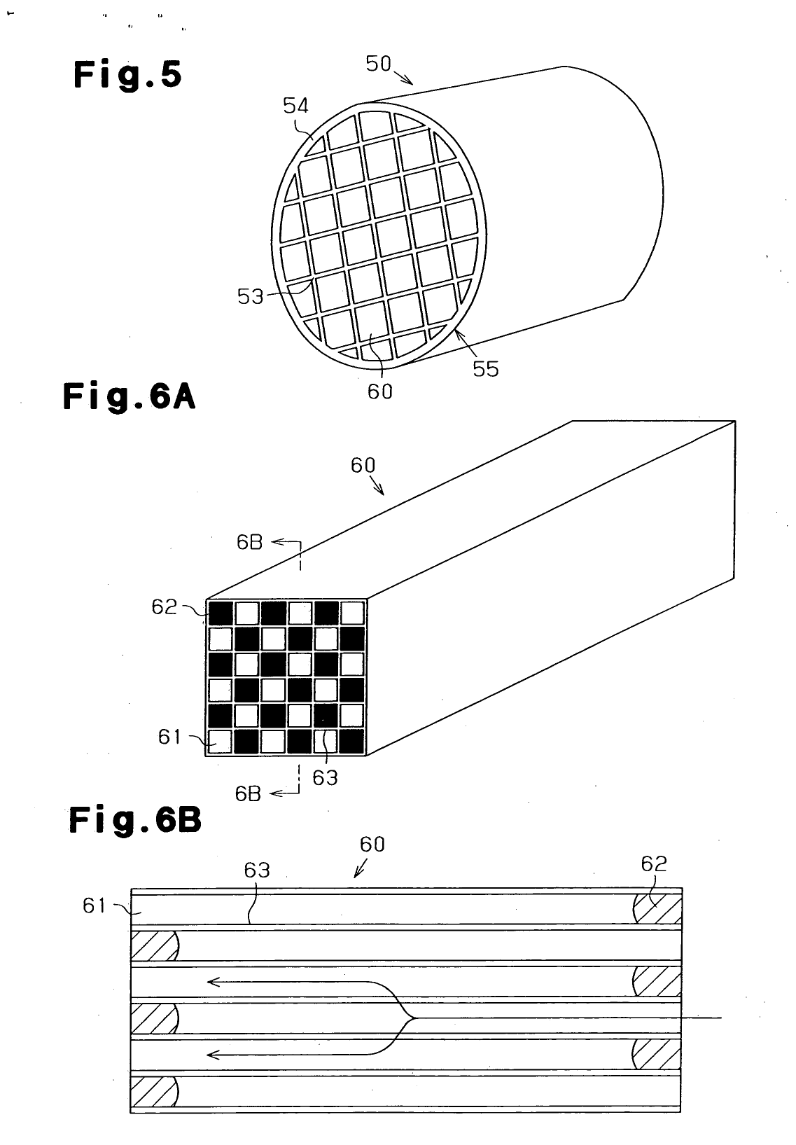

FIG. 5 shows a particulate filter (honeycomb structure) 50. The particulate filter 50 is manufactured by binding a plurality of porous silicon carbide fired objects, or ceramic members 60 as shown in FIG. 6A. The ceramic members 60 are bonded to each other by a bonding layer 53 to form a single ceramic block 55. The shape and dimensions of the ceramic block 55 are adjusted in accordance with its application. For example, the ceramic block 55 is cut to a length in accordance with its application and trimmed into a shape (e.g., cylindrical pillar, elliptic pillar, or rectangular pillar) that is in accordance with its application. The side surface of the shaped ceramic block 55 is covered with a coating layer 54.

As shown in FIG. 6(B), each ceramic member 60 includes partition walls 63 defining a plurality of gas passages 61, which extend longitudinally. At each end of the ceramic member 60, the openings of the gas passages 61 are alternately closed by sealing plugs 62. More specifically, each gas passage 61 has one end closed by the sealing plug 62 and another end that is open. Exhaust gas flows into a gas passage 61 from one end of the particulate filter 50, passes through the partition wall 63 into an adjacent gas passage 61, and flows out from the other end of the particulate filter 50. When the exhaust gas passes through the partition wall 63, particulate matter (PM) in the exhaust gas are trapped by the partition wall 63. In this manner, purified exhaust gas flows out of the particulate filter 50.

The particulate filter 50, which is formed of a silicon carbide fired objects, has extremely high heat resistance and is easily regenerated. Therefore, the particulate filter 50 is suitable for use in various types of large vehicles and diesel engine vehicles.

The bonding layer 53, for bonding the ceramic members 60, functions as a filter for removing the particulate matter (PM). The material of the bonding layer 53 is not particularly limited but is preferably the same as the material of the ceramic member 60.

The coating layer 54 prevents leakage of exhaust gas from the side surface of the particulate filter 50 when the particulate filter 50 is installed in the exhaust gas passage of an internal combustion engine. The material for the coating layer 54 is not particularly limited but is preferably the same as the material of the ceramic member 60.

Preferably, the main component of each ceramic member 60 is silicon carbide. The main component of the ceramic member 60 may be silicon-containing ceramics obtained by mixing silicon carbide with metal silicon, ceramics obtained by combining silicon carbide with silicon or silicon oxychloride, aluminum titanate, carbide ceramics other than silicon carbide, nitride ceramics, or oxide ceramics.

When about 0 to about 45% by weight of metal silicon with respect to the ceramic member 60 is contained in the firing material, some or all of the ceramic powder is bonded together with the metal silicon. Therefore, the ceramic member 60 has high mechanical strength.

A preferable average pore size for the ceramic member 60 is about 5 to about 100 μm. The ceramic member 60 having an average pore size in a range between about 5 to about 100 μmcan not be clogged with exhaust gas and can collect particulate matter in the exhaust gas without allowing the particulate matter passing through the partition walls 63 of the ceramic member 60.

The porosity of the ceramic member 60 is not particularly limited but is preferably about 40 to about 80%. The ceramic member 60 having a porosity in a range between about 40 to about 80% can not be clogged with exhaust gas and the mechanical strength of the ceramic member 60 is improved and thus the ceramic member 60 will not be easily damaged.

A preferable firing material for producing the ceramic member 60 is ceramic particles. It is preferable that the ceramic particles have a low degree of shrinkage during firing. A particularly preferable firing material for producing the particulate filter 50 is a mixture of 100 parts by weight of relatively large ceramic particles having an average particle size of about 0.3 to about 50 μm and about 5 to about 65 parts by weight of relatively small ceramic particles having an average particle size of about 0.1 to about 1.0 μm.

The shape of the particulate filter 50 is not limited to a cylindrical shape and may have an elliptic pillar shape or a rectangular pillar shape.

The method for manufacturing the particulate filter 50 will now be described.

A firing composition (material), which contains silicon carbide powder (ceramic particles), a binder, and a dispersing solvent, is prepared with a wet type mixing mill such as an attritor. The firing composition is sufficiently kneaded with a kneader and molded into a molded product (firing subject 11) having the shape of the ceramic member 60 shown in FIG. 6A (hollow square rod) by performing, for example, extrusion molding.

The type of the binder is not particularly limited but is normally methyl cellulose, carboxymethyl cellulose, hydroxyethyl cellulose, polyethylene glycol, phenolic resin, or epoxy resin. The preferred amount of the binder is 1 to 10 parts by weight relative to 100 parts by weight of silicon carbide powder.

The type of the dispersing solvent is not particularly limited but is normally a water-insoluble organic solvent such as benzene, a water-soluble organic solvent such as methanol, or water. The preferred amount of the dispersing solvent is determined such that the viscosity of the firing composition is within a certain range.

The firing subject 11 is dried. One of the openings is sealed in some of the gas passages 61 as required. Then, the firing subject 11 is dried again.

A plurality of the firing subjects 11 is dried and placed in the firing jigs 11a. A plurality of the firing jigs 11a are stacked on the support base 11b. The support base 11b is moved by the conveying rollers 16 and passes through the firing chamber 14. While passing through the firing chamber 14, the firing subjects 11 are fired thereby manufacturing the porous ceramic member 60.

A plurality of the ceramic members 60 are bonded together with the bonding layers 53 to form the ceramic filter block 55. The dimensions and the shape of the ceramic block 55 are adjusted in accordance with its application. The coating layer 54 is formed on the side surface of the ceramic block 55. This completes the particulate filter 50.

Examples of the preferred embodiment will now be described. It should be understood, however, that the present invention is not limited to these examples.

### EXAMPLES 1 to 3 and COMPARATIVE EXAMPLES 1 to 3

In examples 1 to 3, the rod heaters 23 were formed of a carbon material (hereafter referred to as the CIP material) produced by the cold isotropic pressing (CIP) method. In comparative examples 1 to 3, the rod heaters 23 were formed of a carbon material manufactured through extrusion molding (extrusion-molded material). The rod heaters 23 were arranged in the firing furnace 10 and supplied with current to generate resistance heat. The voltage drop time (hr) in the rod heaters 23 was measured. A longer voltage drop time prolongs durability. The measurement of the voltage drop time was performed in the firing furnace 10 under an argon (Ar) atmosphere at a temperature of approximately 2200° C.

Table 1 shows evaluation results and various physical properties of the carbon materials used in examples 1 to 3 and comparative examples 1 to 3.

TABLE 1

| | Production | Volume Density | Porosity | Thermal Conductivity | Specific resistance | Voltage Drop |
|---|---|---|---|---|---|---|
| | Method | (g/cm³) | (%) | (W/m · K) | value (μΩcm) | Time (hr) |
| Ex. 1 | CIP | 1.83 | 15 | 140 | 1200 | 4000 |
| Ex. 2 | CIP | 1.85 | 10 | 152 | 1150 | 4300 |
| Ex. 3 | CIP | 1.8 | 18 | 128 | 1250 | 3800 |
| Com. Ex. 1 | Extrusion | 1.7 | 26 | 170 | 800 | 1440 |
| Com. Ex. 2 | Extrusion | 1.2 | 30 | 138 | 900 | 1350 |
| Com. Ex. 3 | Extrusion | 1 | 41 | 80 | 1100 | 1200 |
| Reference | CIP | 1.5 | 26 | 115 | 1370 | 2100 |
| Ex. | | | | | | |

As shown in table 1, the CIP materials (examples) have lower porosities than those of the extrusion-molded materials (comparative examples). Thus, a small number of pores are exposed from the surface of the rod heater 23 in the examples, whereas a large of number pores are exposed from the surface of the rod heater 23 in the comparative examples.

The voltage drop time in examples 1 to 3 is longer than that in comparative examples 1 to 3 by two times or more, and the durability of the rod heaters in examples 1 to 3 is thus longer than that in comparative examples 1 to 3. The reason for this is assumed to be as follows. The rod heaters 23 of the comparative examples have a large number of pores exposed from the surface and are apt to being damaged by meltdown or surface erosion caused by high temperature gas. In contrast, the rod heaters 23 of examples 1 to 3 have a small number of pores exposed from the surface and are less likely to be damaged by meltdown or surface erosion caused by high temperature gas.

According to the measurement data of examples 1 to 3, in order to increase the durability of the rod heaters 23, the preferred volume density for the CIP material is 1.8 g/cm³ or more, and the preferred porosity is 18% or less. In the reference example, the rod heaters 23 were formed of a CIP material but the volume density and porosity were not included in the preferable ranges. According to the measurement data of the reference example, it was found that the rod heaters 23 formed of the CIP material may have a longer voltage drop time than comparative examples 1 to 3 even if the volume density and the porosity were not included in the preferable ranges.

### EXAMPLE 4

A method for manufacturing the porous ceramic fired object with the firing furnaces of examples 1 to 3 will now be described.

A powder of α-type silicon carbide having an average particle size of 10 μm (60% by weight) was wet mixed with a powder of α-type silicon carbide having an average particle size of 0.5 μm (40% by weight). Five parts by weight of methyl cellulose, which functions as an organic binder, and 10 parts by weight of water were added to 100 parts by weight of the mixture and kneaded to prepare a kneaded mixture. A plasticizer and a lubricant were added to the kneaded mixture in small amounts and further kneaded. The kneaded mixture was then extruded to produce a silicon carbide molded product (firing subject).

The molded product was then subjected to primary drying for three minutes at 100° C. with the use of a microwave drier. Subsequently, the molded product was subjected to secondary drying for 20 minutes at 110° C. with the use of a hot blow drier.

The dried molded product was cut to expose the open ends of the gas passages. The openings of some of the gas passages were filled with silicon carbide paste to form sealing plugs 62.

Ten dried molded products (firing subjects) 11 were placed on a carbon platform, which was held on each of the carbon firing jigs 11a. Five firing jigs 11a were stacked on top of one another. The uppermost firing jig 11a was covered with a cover plate. Two such stacked bodies (stacked firing jigs 11a) were placed on the support base 11b.

The support base 11b, carrying the molded products 11, was loaded into a continuous degreasing furnace. The molded products 11 were degreased in an atmosphere of an air and nitrogen gas mixture having an oxygen concentration adjusted to 8% and heated to 300° C.

After the degreasing, the support base 11b was loaded into the continuous firing furnace 10. The molded products 11 were fired for three hours at 2200° C. in an atmosphere of argon gas under atmospheric pressure to manufacture a porous silicon carbide fired object (ceramic member 60) having the shape of a square pillar.

Adhesive paste was prepared, containing 30% by weight of alumina fibers with a fiber length of 20 μm, 20% by weight of silicon carbide particles having an average particle size of 0.6 μm, 15% by weight of silicasol, 5.6% by weight of carboxymethyl cellulose, and 28.4% by weight of water. The adhesive paste is heat resistive. The adhesive paste was used to bond sixteen ceramic members 60 together in a bundle of four columns and four rows to produce a ceramic block 55. The ceramic block 55 was cut and trimmed with a diamond cutter to adjust the shape of the ceramic block 55. An example of the ceramic block 55 is a cylindrical shape having a diameter of 144 mm and a length of 150 mm.

A coating material paste was prepared by mixing and kneading 23.3% by weight of inorganic fibers (ceramic fibers such as alumina silicate having a fiber length of 5 to 100 μm and a shot content of 3%), 30.2% by weight of inorganic particles (silicon carbide particles having an average particle size of 0.3 μm), 7% by weight of an inorganic binder (containing 30% by weight of SiO₂ in sol), 0.5% by weight of an organic binder (carboxymethyl cellulose), and 39% by weight of water.

The coating material paste was applied to the side surface of the ceramic block 55 to form the coating layer 54 having a thickness of 1.0 mm, and the coating layer 54 was dried at 120° C. This completed the particulate filter 50.

The particulate filter 50 of example 4 satisfies various characteristics required for an exhaust gas purifying filter. Since a plurality of the ceramic members 60 are continuously fired in the firing furnace 10 at a uniform temperature, the difference between the ceramic members 60 in characteristics, such as pore size, porosity, and mechanical strength, is reduced. Thus, the difference between the particulate filters 50 in characteristics is also reduced.

As described above, the firing furnace of the present invention is suitable for manufacturing porous ceramic fired object.

It should be apparent to those skilled in the art that the present invention may be embodied in many other specific forms without departing from the spirit or scope of the invention. Particularly, it should be understood that the preferred embodiment and examples may be modified and embodied in the following forms.

The cold isotropic pressing method used in the embodiment is a wet method that applies pressure to the rubber mold 44 immersed in the pressurizing medium 41. However, the cold isotropic pressing method may be changed to a dry method that applies pressure to the rubber mold incorporated in the pressure container 42.

The rod heaters 23 may be formed of a silicon carbide ceramic material.

The rod heaters 23 and the connectors 25 may be formed integrally.

The shape of the heating elements (rod heaters 23) is not limited to the cylindrical shape and may have other shapes. For example, the heating elements may have a planar shape, a rectangular rod shape, or a rectangular bar shape.

The firing subject 11 may have any shape.

The firing furnace 10 does not have to be a continuous firing furnace and may be, for example, a batch firing furnace.

The firing furnace 10 may be used for purposes other than as a manufacturing process for ceramic products. For example, the firing furnace 10 may be used as a heat treatment furnace or reflow furnace used in a manufacturing process for semiconductors or electronic components.

In example 4, the particulate filter 50 includes a plurality of filter elements 60 which are bonded to each other by the bonding layer 53 (adhesive paste). Instead, a single filter element 60 may be used as the particulate filter 50.

The coating layer 54 (coating material paste) may or may not be applied to the side surface of each of the filter elements 60.

In each end of the ceramic member 60, all the gas passages 61 may be left open without being sealed with the sealing plugs 62. Such a ceramic fired object is suitable for use as a catalyst carrier. An example of a catalyst is a noble metal, an alkali metal, an alkali earth metal, an oxide, or a combination of two or more of these components. However, the type of the catalyst is not particularly limited. The noble metal may be platinum, palladium, rhodium, or the like. The alkali metal may be potassium, sodium, or the like. The alkali earth metal may be barium or the like. The oxide may be a Perovskite oxide (e.g., La_{0.75}K_{0.25}MnO₃), CeO₂ or the like. A ceramic fired object carrying such a catalyst may be used, although not particularly limited in any manner, as a so-called three-way catalyst or NOx absorber catalyst for purifying exhaust gas in automobiles. After the manufacturing a ceramic fired object, the fired object may be carried in a ceramic fired object. Alternatively, the catalyst may be carried in the material (inorganic particles) of the ceramic fired object before the ceramic fired object is manufactured. An example of a catalyst supporting method is impregnation but is not particularly limited in such a manner.

The present examples and embodiments are to be considered as illustrative and not restrictive, and the invention is not to be limited to the details given herein, but may be modified within the scope and equivalence of the appended claims.

What is claimed is:

1. A firing furnace for firing a firing subject, the firing furnace comprising:
a housing including a firing chamber for receiving the firing subject; and
a plurality of heating elements for generating heat when supplied with current to heat the firing subject in the firing chamber, each of the heating elements being formed of a material containing irregularly oriented crystal grains.

2. The firing furnace according to claim 1, wherein the material is a ceramic material formed by a cold isotropic pressing method.

3. The firing furnace according to claim 2, wherein the ceramic material has a porosity in a range of about 5% to about 20% in terms of a value measured by performing mercury intrusion porosimetry.

4. The firing furnace according to claim 2, wherein the ceramic material is carbon.

5. The firing furnace according to claim 1, further comprising:
a support member for supporting the plurality of heating elements, the heating elements each being indirectly supported by the housing in a state connected to the support member.

6. The firing furnace according to claim 5, wherein the support member is formed of a material having a porosity adjusted within a range of about 5% to about 20% in terms of a value measured by performing mercury intrusion porosimetry.

7. The firing furnace according to claim 1, wherein the firing subject is fired at a first temperature and a second temperature, which is higher than the first temperature.

8. The firing furnace according to claim 1, wherein the furnace is a continuous firing furnace for continuously firing a plurality of the firing subjects.

9. A method for manufacturing a porous ceramic fired object, the method comprising:
forming a firing subject from a composition containing ceramic powder; and
firing the firing subject with a firing furnace including a housing having a firing chamber and a plurality of heating elements formed of a material containing irregularly oriented crystal grains and generating heat when supplied with current to heat the firing subject in the firing chamber.

10. The method according to claim 9, wherein the material of the heating elements is a ceramic material formed by a cold isotropic pressing method.

11. The method according to claim 10, wherein the ceramic material has a porosity of about 5% to about 20% in terms of a value measured by performing mercury intrusion porosimetry.

12. The method according to claim 10, wherein the ceramic material is carbon.

13. The method according to claim 9, wherein the firing furnace further includes a support member for supporting the plurality of heating elements, the heating elements each being indirectly supported by the housing in a state connected to the support member.

14. The method according to claim 13, wherein the support member is formed of a material having a porosity adjusted within a range of about 5% to about 20% in terms of a value measured by performing mercury intrusion porosimetry.

15. The method according to claim 9, wherein the step of firing includes firing the firing subject at a first temperature and a second temperature, which is higher than the first temperature.

16. The production method according to claim 9, wherein the firing furnace is a continuous firing furnace, and the step of firing includes continuously firing a plurality of the firing subjects.

17. A furnace for performing firing upon subjects, the furnace comprising:
a housing including a chamber for receiving and firing the subjects; and
a plurality of resistance heating elements disposed for generating heat in the chamber when the resistance heating elements are supplied with electric current for heating and firing the subjects in the chamber, with each resistance heating element being comprised of a ceramic material having isotropic characteristics.

18. The furnace of claim 17, wherein the ceramic material decreases differences in electrical characteristics between the resistance heating elements.

19. The furnace of claim 17, wherein the resistance heating elements have electric resistances substantially identical to one another.

20. The furnace of claim 17, wherein the ceramic material comprises a plurality of irregularly oriented crystal grains.
